(19) United States
(12) Patent Application Publication
(10) Pub. No.: US 2007/0194714 A1
(43) Pub. Date: Aug. 23, 2007

(54) PLASMA DISPLAY PANEL

(75) Inventor: Ji Hoon SOHN, Gyeonggi-do (KR)

Correspondence Address: FISH & RICHARDSON P.C., P.O. BOX 1022, MINNEAPOLIS, MN, 55440-1022, US

(73) Assignee: LG ELECTRONICS INC., Seoul (KR)

(21) Appl. No.: 11/677,383

(22) Filed: Feb. 21, 2007

(30) Foreign Application Priority Data
Feb. 22, 2006 (KR) 10-2006-0017174

(51) Int. Cl. H01J 17/49; H01J 5/16; H01J 61/40

(52) U.S. Cl. 313/582; 313/111; 313/110

(57) ABSTRACT

A plasma display panel is disclosed, which does not require an optical filter or reduces the cost of the optical filter. In the plasma display panel which comprises an upper panel and a lower panel, the upper panel includes an EMI shielding layer.

This application claims the benefit of the Korean Patent Application No. 10-2006-0017174, filed on Feb. 22, 2006, which is hereby incorporated by reference as if fully set forth herein.

### BACKGROUND OF THE INVENTION

1. Field of the Invention

The present invention relates to a plasma display panel, and more particularly, to a plasma display panel which includes an electromagnetic shielding function and/or a color correction function.

2. Discussion of the Related Art

A plasma display panel (hereinafter, referred to as “PDP”) is a kind of a light-emitting device that displays a picture image using discharge phenomenon. The PDP does not require an active device per cell to simplify a fabrication process, facilitates a large size of a screen, and has fast response speed. In this respect, the PDP has received much attention as a display device of an image display apparatus having a large sized screen.

The aforementioned PDP, as shown in FIG. 1, has an overlap structure in which an upper panel 10 and a lower panel 20 face and overlap each other. The upper panel 10 includes an upper substrate 11 and a pair of sustain electrodes 12, wherein the sustain electrodes 12 are arranged inside the upper substrate 11. In general, the sustain electrodes 12 are divided into a transparent electrode and a bus electrode.

The sustain electrodes 12 are coated with a dielectric layer 13 for AC driving. A protective layer 14 is formed on a surface of the dielectric layer 13.

Meanwhile, an address electrode 22 is arranged on a lower substrate 21 inside the lower panel 20, and a dielectric layer 23 is formed on the address electrode 22. A stripe or well type barrier 24 is formed on the dielectric layer 23 to partition a discharge cell area. Phosphor layers 26 of red, blue and green are coated on a cell partitioned by the barrier 24 to display colors, thereby constituting sub-pixels.

A discharge cell 25 is defined per sub-pixel by the barrier 24, and a discharge gas is sealed in the discharge cell 25. One pixel is comprised of three sub-pixels.

The aforementioned PDP generates a plurality of electromagnetic waves due to high frequency discharge. The electromagnetic waves may weaken functions of peripheral electronic circuits and cause a malfunction in their operation. This phenomenon is generally referred to as “electromagnetic interference” (EMI).

The EMI is defined by regulations that ‘electromagnetic waves radiated or conducted interfere with functions of other devices.’ It is required that the electromagnetic waves generated from the PDP be shielded.

### SUMMARY OF THE INVENTION

Accordingly, the present invention is directed to a plasma display panel that substantially obviates one or more problems due to limitations and disadvantages of the related art.

An object of the present invention is to provide a plasma display panel which includes at least some of functions of an optical filter, such as an electromagnetic shielding function and a color correction function.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, in a plasma display panel according to the present invention, which comprises an upper panel and a lower panel, the upper panel preferably includes an EMI shielding layer.

In another aspect of the present invention, a plasma display panel comprises an upper substrate, an EMI shielding layer formed of a conductive material on the upper substrate, a first dielectric layer arranged on the EMI shielding layer, a plurality of sustain electrodes arranged on the first dielectric layer, a second dielectric layer arranged on the sustain electrodes, and a protective layer arranged on the second dielectric layer.

In other aspect of the present invention, a plasma display panel comprises an EMI shielding layer arranged on a substrate of the panel, and a color correction layer arranged on the EMI shielding layer.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a perspective view illustrating one example of a general plasma display panel;

FIG. 2 is a sectional view illustrating a plasma display panel and an optical filter according to the present invention;

FIG. 3 is a sectional view illustrating one example of a plasma display panel according to the present invention;

FIG. 4 is a sectional view illustrating one example of a plasma display panel and an EMI shielding layer according to the present invention;

FIG. 5 is a sectional view illustrating one example of a plasma display panel and a ground portion according to the present invention; and

FIG. 6 is a sectional view illustrating another example of a plasma display panel according to the present invention.

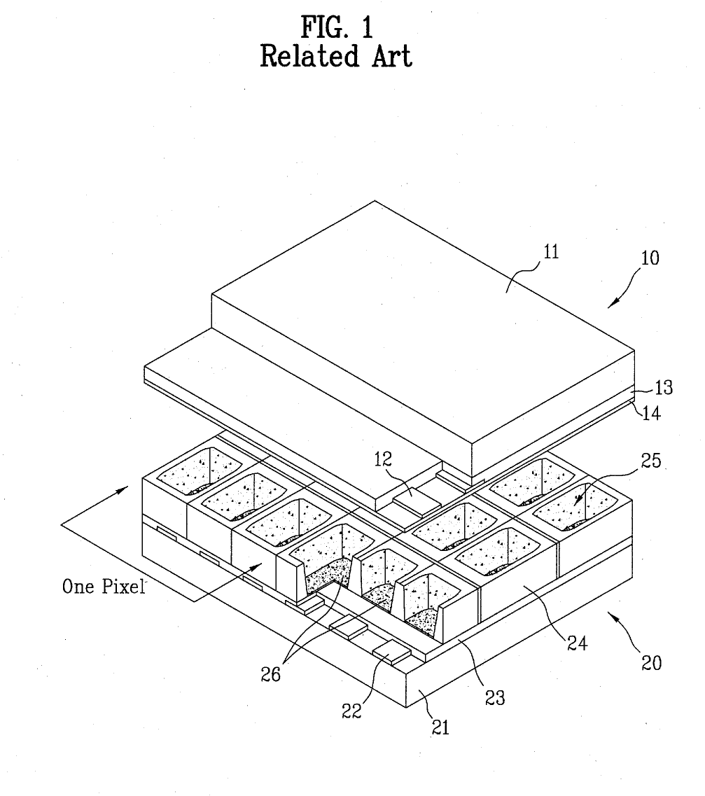

### DETAILED DESCRIPTION OF THE INVENTION

Reference will now be made in detail to the preferred embodiments of the present invention, examples of which are illustrated in the accompanying drawings.

It will be apparent to those skilled in the art that various modifications and variations can be made in the present invention, and their specific embodiments will be exemplarily illustrated in the drawings and described in detail in the following. However, it is not intended that the present invention is limited to the disclosed embodiments, and it is intended that the present invention covers the modifications and variations of this invention provided they come within the scope of the appended claims and their equivalents.

Wherever possible, the same reference numbers will be used throughout the drawings to refer to the same or like parts. Dimensions of layers and areas in the drawings have been overdrawn for clarification. Each embodiment described herein includes an embodiment of complementary conductivity.

It is to be understood that when an element such as layer, area or substrate is referred to exist “on” other element, it may directly exist on other element or an intermediate element may exist between them. It is to be understood that when a part of an element such as surface is expressed as ‘inner,’ it is far away from the outside of the device than other parts of the element.

Furthermore, relative terms such as ‘beneath’ or ‘overlies’ will be used to describe the relation between one layer or area and other layer or between one layer of an area and the area with respect to a substrate or a reference layer as shown.

It is to be understood that these terms are intended to cover another aspects of devices in addition to aspects depicted in the drawings. Finally, the term ‘directly’ means that no element is interposed between devices. The term ‘and/or’ includes one or more combinations of related lists, and all combinations.

It is to be understood that although the terms ‘first˜’ and ‘second˜’ are used to describe various elements, components, areas, layers and/or zones, the elements, components, areas, layers and/or zones are not limited by the terms ‘first˜’ and ‘second˜.’

These terms are only used to classify any one element, component, area, layer or zone from other areas, layers or zones. Accordingly, a first area, layer, or zone may hereinafter be referred to as a second area, layer, or zone.

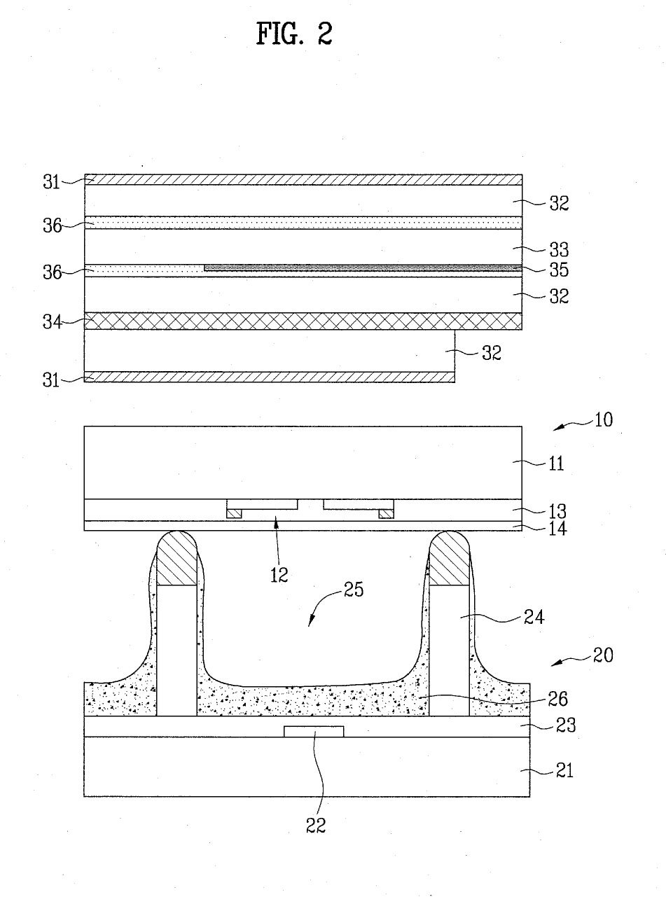

FIG. 2 illustrates structures of PDP panels 10 and 20 and an optical filter 30. In other words, the optical filter 30 is arranged at a certain interval from the upper panel 10 of the PDP. As shown in FIG. 2, anti-reflection layers (AR layers) 31 are formed on a material 32 such as PET at both sections. A glass 33, an EMI shielding layer 34, a black frame 35, and an adhesive layer 36 are formed between the anti-reflection layers 31, wherein the adhesive layer 36 serves to bond the glass 33, the EMI shielding layer 34, and the black frame 35 to one another.

The EMI shielding layer 34 is also formed on a material 32 such as PET. If a copper mesh type shielding layer is used, the EMI shielding layer is formed in such a manner that a copper layer is formed and then exposed and etched in a mesh pattern. In this case, the mesh pattern may be tilted at a certain angle to avoid moiré.

Furthermore, a conductive type EMI shielding layer may be formed in such a manner that an indium tin oxide (ITO) layer and a metal layer such as an Ag layer are repeatedly layered. The ITO layer may be used as a transparent electrode.

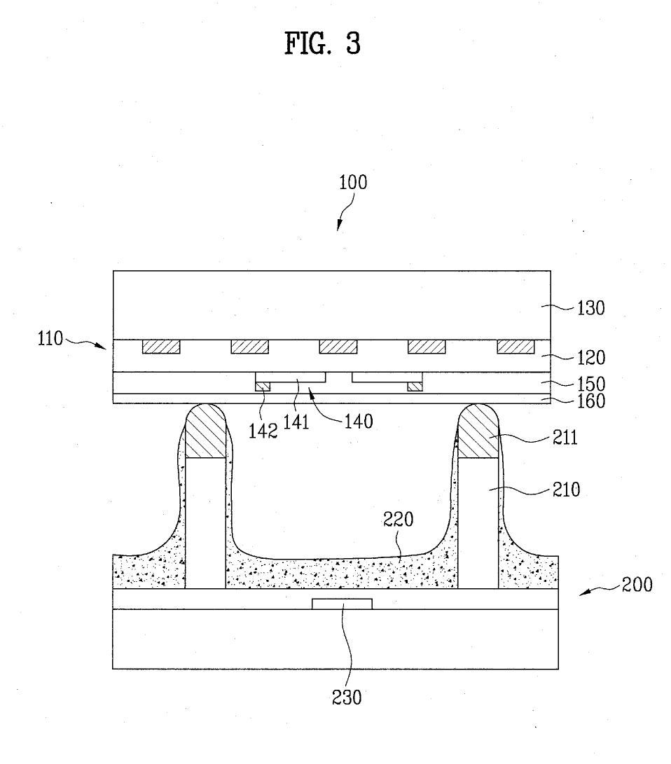

Meanwhile, as shown in FIG. 3, an EMI shielding layer 110 is formed of a conductive material inside an upper panel 100 of the PDP. A first dielectric layer 120 is formed on the EMI shielding layer 110 to insulate the EMI shielding layer 110.

As shown in FIG. 3, the EMI shielding layer 110 is preferably formed on a substrate 130 of the upper panel 100.

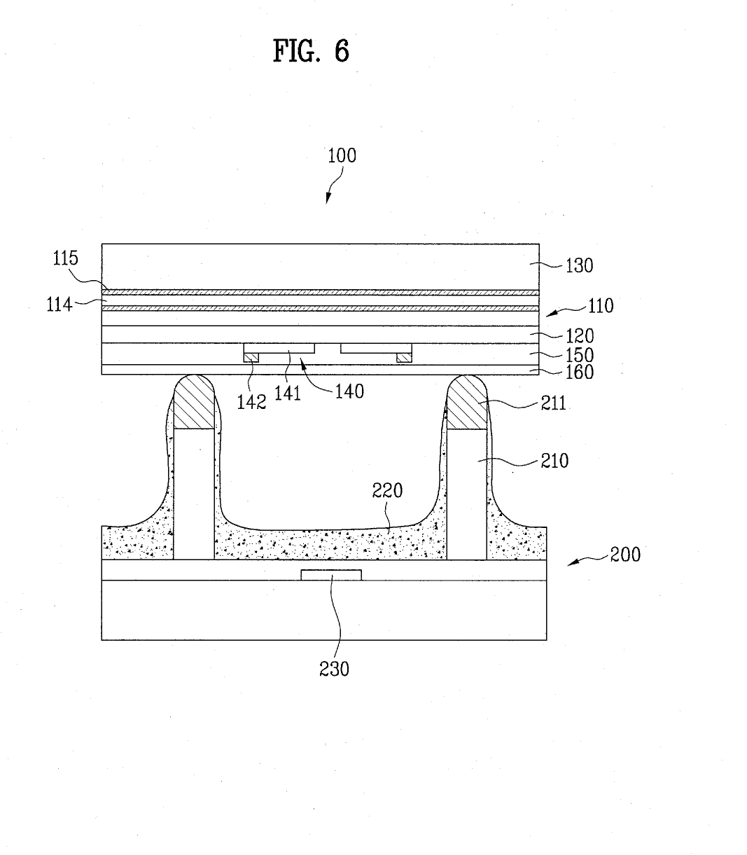

The EMI shielding layer 110 may be formed of a conductive material in a mesh pattern or a stripe pattern. Alternatively, the EMI shielding layer 110 may be formed in such a manner that an ITO layer and a conductive material layer (generally, Ag layer) are alternately formed (see FIG. 6).

If the EMI shielding layer 110 may be formed of a conductive material in a mesh pattern or a stripe pattern, a black pigment is added to the pattern of the EMI shielding layer 110, so that the EMI shielding layer 110 may serve as a black matrix.

In other words, the EMI shielding layer 110 shields EMI occurring in the PDP panel so as to allow peripheral electronic devices not to be affected by such electronic waves, and at the same time the pattern constituting the EMI shielding layer 110 improves contrast of the PDP panel.

The EMI shielding layer 110 may be formed by a pattern printing method, an exposure method after printing, an ink jet head method, and an off-set printing method.

To this end, the EMI shielding layer 110 may be formed in such a manner that a conductive material such as Cu, Ag, and Al and a black pigment such as black ceramic are mixed with a vehicle containing a solvent.

The first dielectric layer 120 is provided with sustain electrodes 140 at constant intervals. The sustain electrodes 140 are generally comprised of transparent electrodes 141 and bus electrodes 142. As the case may be, the sustain electrodes 140 may be comprised of bus electrodes 142 only.

Furthermore, a second dielectric layer 150 may further be provided on the sustain electrodes 140 to insulate the sustain electrodes 140. A protective layer 160 may be formed of a material such as MgO on the second dielectric layer 150.

At this time, the first dielectric layer 120 is thicker than the distance between the sustain electrodes 140 to prevent discharge characteristics from being deteriorated.

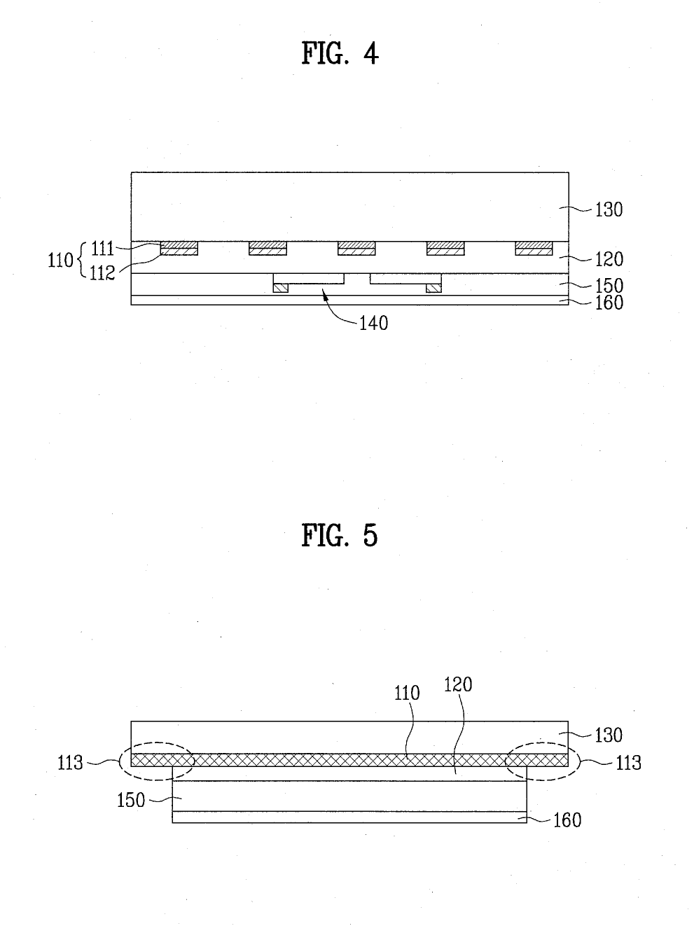

Meanwhile, the EMI shielding layer 110 may be formed by one time process. In the case that conductivity of materials for performing the process is relatively low, as shown in FIG. 4, a first layer 111 having high resistance is first formed, and then a second layer 112 is formed of a material having low resistance on the first layer 111, whereby conductivity is improved.

The first layer 111 is formed at a side toward a direction viewed with the naked eye of a user and has a high black density pattern while the second layer 112 is formed at the other side and has a low black density pattern, thereby constituting a double structure.

The resistance and black density can be controlled by controlling a content ratio of a conductive material such as Cu, Ag, and Al and a black pigment such as black ceramic.

In general, a conductive mesh layer within an optical filter should be tilted at a certain angle not a right angle with respect to a contour of the panel so as not to cause moiré between a meshed grid pattern and a regular pattern of the panel.

However, the aforementioned EMI shielding layer 110 can have a horizontal stripe pattern or a vertical stripe pattern as well as a titled mesh pattern.

At this time, the range of angle of the tilted mesh pattern is about 30˜60° with respect to the panel.

In other words, as shown in FIGS. 3 and 4, the EMI shielding layer 110 is arranged to have a constant position with respect to other patterns, which can cause moiré, such as the bus electrodes 142, a barrier 210 of a lower panel 200, a black top 211, or an address electrode 230. In this case, the EMI shielding layer 110 can have a horizontal stripe pattern or a vertical stripe pattern. Even in the case that the EMI shielding layer 110 has a mesh pattern, the EMI shielding layer 110 may not be tilted.

In case the EMI shielding layer 110 has a stripe pattern, the pitch of the stripe pattern may be formed smaller than that of the bus electrodes of the PDP. In the other hand, the pitch of the stripe pattern may be formed smaller than that of the discharge cell forming the discharge area of the PDP.

Also, the width of the stripe pattern of the EMI shielding layer 110 may be narrower than that of the bus electrodes of the PDP.

Meanwhile, the upper panel 100 may include a color correction layer having a color correction function which is one of functions of the optical filter. In this case, the PDP may not require a separate optical filter.

The color correction function includes a near infrared shielding function, a neon (Ne) light shielding function, and a color temperature correction function. The color correction layer having such a color correction function may be formed at any one of the upper panel 100 as a separate layer. Alternatively, the color correction function may be included in the first dielectric layer 120 or the second dielectric layer 150.

The near infrared rays may be generated by Xe gas used as a discharge gas, and the neon (Ne) light may be generated either in a phosphor layer 220 or by Ne gas used as a discharge gas.

As shown in FIG. 5, the first dielectric layer 120 which covers the EMI shielding layer 110 has an area narrower than that of the EMI shielding layer 110. Alternatively, the first dielectric layer 120 may form a portion that exposes the EMI shielding layer 110, and may use the portion as a ground portion 111.

In other words, although it is important that the EMI shielding layer 110 serves as a conductive layer inside an effective screen of the panel, it is also important that the EMI shielding layer 110 serves as a ground portion outside the effective screen. The portion that exposes the EMI shielding layer 110 may be grounded to a case of the PDP.

The ground portion 111 can prevent short between conductive materials constituting the EMI shielding layer 110 and effectively ground the EMI shielding layer 110 if the substrate 130 of the upper panel is sufficiently great.

Meanwhile, the opening ratio of the EMI shielding layer 110 may be within the region of 70˜99%, in case the stripe or mesh pattern is used such that does not influence the brightness of the PDP.

The EMI shielding layer 110 may be formed on the barrier rib of PDP. Furthermore, the EMI shielding layer 110 may be formed along one direction on the barrier rib. For example, the EMI shielding layer 110 may be formed one side direction on a well type barrier rib such that the EMI shielding layer forms a stripe pattern.

### First Embodiment

Hereinafter, an example of forming a mesh pattern or a stripe pattern of a conductive material as the EMI shielding layer 110 will be described with reference to FIG. 3 and FIG. 4.

First, the EMI shielding layer 110 can be formed on the substrate 130 of the upper panel 100 by a pattern printing method, an exposure method after printing, an ink jet head method, and an off-set printing method.

To this end, the EMI shielding layer 110 can be formed in such a manner that a conductive material such as Cu, Ag, and Al and a black pigment such as black ceramic are mixed with a vehicle containing a solvent.

At this time, as described above, the first layer 111 having high resistance and high black density can be formed toward the substrate 130 while the second layer having relatively low resistance and low black density can be formed on the first layer 111.

Furthermore, the EMI shielding layer 110 may be formed by using electroless plating. In other words, a seed layer can be formed on the substrate 130 in a specific pattern, and the EMI shielding layer 110 can be formed by plating the seed layer. At this time, the seed layer can contain a black pigment and thus serve as a black matrix.

Both the mesh pattern and the stripe pattern can be used as the pattern constituting the EMI shielding layer 110. The EMI shielding layer 110 can be titled at a certain angle not a right angle with respect to the contour of the panel.

Furthermore, the stripe pattern can be formed in such a manner that horizontal conductive lines or vertical conductive lines are formed with respect to the panel.

Once the EMI shielding layer 110 is formed, the first dielectric layer 120 is formed as an insulating layer that insulates the EMI shielding layer 110.

Afterwards, the sustain electrodes 140, the second dielectric layer 150 and the protective layer 160 can be formed by a typical method for fabricating a PDP.

Furthermore, a color correction layer may separately be provided in the first dielectric layer 120 or the second dielectric layer 150. Alternatively, a material having a color correction function may be contained in the first dielectric layer 120 of the second dielectric layer 150.

### Second Embodiment

Hereinafter, an example of alternately forming an ITO layer 114 and an Ag layer 115 as the EMI shielding layer 110 will be described with reference to FIG. 6.

As shown in FIG. 6, the ITO layer 114 and the Ag layer 115 are alternately formed on the substrate 130 of the upper panel 100. The Ag layer 115 may directly be formed on the substrate 130. Alternatively, the Ag layer 115 may be formed after the ITO layer 114 is formed.

The ITO layer 114 and the Ag layer 115 are alternately layered at least two times or more by a sputtering method.

As shown in FIG. 6, the Ag layer 115 is formed more thinly than the ITO layer 114 to maintain transparency over the whole panel.

Afterwards, the first dielectric layer 120 is formed to insulate the EMI shielding layer 110 comprised of the ITO layer 114 and the Ag layer 115. The other structure of the EMI shielding layer 110 is the same as that of the EMI shielding layer according to the first embodiment.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A plasma display panel which comprises an upper panel and a lower panel, the upper panel includes an EMI shielding layer.

2. The plasma display panel as claimed in claim 1, wherein the EMI shielding layer is formed on a substrate of the upper panel.

3. The plasma display panel as claimed in claim 1, wherein the EMI shielding layer has a mesh pattern of a conductive material.

4. The plasma display panel as claimed in claim 3, wherein the mesh pattern is tilted at a certain angle with respect to a contour of the panel.

5. The plasma display panel as claimed in claim 4, the range of angle of the tilted mesh pattern is about 30˜60° with respect to the panel.

6. The plasma display panel as claimed in claim 1, wherein the EMI shielding layer has a stripe pattern of a conductive material.

7. The plasma display panel as claimed in claim 6, wherein the stripe pattern comprises horizontal conductive lines to the panel.

8. The plasma display panel as claimed in claim 6, wherein the stripe pattern comprises vertical conductive lines to the panel.

9. The plasma display panel as claimed in claim 6, the pitch of the stripe pattern is formed smaller than that of the bus electrodes of the panel.

10. The plasma display panel as claimed in claim 6, the pitch of the stripe pattern is formed smaller than that of the discharge cell forming the discharge area of the panel.

11. The plasma display panel as claimed in claim 6, the width of the stripe pattern of the EMI shielding layer may be narrower than that of the bus electrodes of the panel.

12. The plasma display panel as claimed in claim 1, wherein the EMI shielding layer comprises a conductive material corresponding to any one of Cu, Ag, and Al.

13. The plasma display panel as claimed in claim 1, wherein the EMI shielding layer is formed of a black layer.

14. The plasma display panel as claimed in claim 13, wherein the black layer includes black ceramic.

15. The plasma display panel as claimed in claim 1, further comprising a dielectric layer insulating the EMI shielding layer.

16. The plasma display panel as claimed in claim 1, wherein the EMI shielding layer is formed in such a manner that an ITO layer and a conductive material layer are alternately arranged.

17. The plasma display panel as claimed in claim 1, wherein the EMI shielding layer is formed at least one layer, the layer comprises a transparent electrode layer and a metal layer.

18. The plasma display panel as claimed in claim 17, the layer comprises ITO and Ag.

19. The plasma display panel as claimed in claim 1, wherein the upper panel further includes a color correction layer.

20. The plasma display panel as claimed in claim 19, wherein the color correction layer includes at least one of a near-infrared shielding layer, a neon light shielding layer, and a color temperature correction layer.

21. The plasma display panel as claimed in claim 1, wherein the EMI shielding layer includes a ground portion at its contour end.

22. The plasma display panel as claimed in claim 1, wherein the EMI shielding layer comprises two layers having different resistances.

23. The plasma display panel as claimed in claim 22, wherein the layer having high resistance of the two layers having different resistances is arranged toward the substrate of the upper panel.

24. The plasma display panel as claimed in claim 1, wherein the EMI shielding layer comprises two layers having different black densities.

25. The plasma display panel as claimed in claim 24, wherein the layer having high black density of the two layers having different black densities is arranged toward the substrate of the upper panel.

26. The plasma display panel as claimed in claim 1, the opening ratio of the EMI shielding layer is within the region of 70˜99%.

27. The plasma display panel as claimed in claim 1, the EMI shielding layer is formed on the barrier rib of the panel.

28. The plasma display panel as claimed in claim 27, the EMI shielding layer is formed along one direction on the barrier rib of the panel.

29. A plasma display panel comprising:
an upper substrate;
an EMI shielding layer formed of a conductive material on the upper substrate;
a first dielectric layer arranged on the EMI shielding layer;
a plurality of sustain electrodes arranged on the first dielectric layer;
a second dielectric layer arranged on the sustain electrodes; and
a protective layer arranged on the second dielectric layer.

30. The plasma display panel as claimed in claim 29, wherein the first dielectric layer is thicker than the distance between the sustain electrodes.

31. The plasma display panel as claimed in claim 29, wherein the first dielectric layer has an area narrower than that of the EMI shielding layer.

32. The plasma display panel as claimed in claim 29, wherein the EMI shielding layer includes a ground portion.

33. The plasma display panel as claimed in claim 32, wherein the ground portion grounds a portion which exposes the EMI shielding layer to the outside of the first dielectric layer.

34. The plasma display panel as claimed in claim 29, wherein the first dielectric layer or the second dielectric layer includes a color correction layer.

35. The plasma display panel as claimed in claim 34, wherein the color correction layer includes at least one of a near-infrared shielding layer, a neon light shielding layer, and a color temperature correction layer.

36. A plasma display panel comprising:
an EMI shielding layer arranged on a substrate of the panel; and
a color correction layer arranged on the EMI shielding layer.
